(19) United States
(12) Patent Application Publication
(10) Pub. No.: US 2020/0064128 A1
(43) Pub. Date: Feb. 27, 2020

(54) SYSTEM FOR NON-DESTRUCTIVE CONDITION MONITORING OF METALLIC STRUCTURES, IN PARTICULAR STEEL PIPES AND STRUCTURES AND STRUCTURES MADE OF FIBRE COMPOSITE MATERIALS AS WELL AS HYBRID MATERIALS

(71) Applicant: Kurotec - KTS Kunststofftechnik GmbH, Stade (DE)

(72) Inventor: Mathias MÜGGENBURG, Stade (DE)

(73) Assignee: Kurotec - KTS Kunststofftechnik GmbH, Stade (DE)

(21) Appl. No.: 16/549,136

(22) Filed: Aug. 23, 2019

(30) Foreign Application Priority Data
Aug. 24, 2018 (EP) 18190715.5

(51) Int. Cl. G01B 17/02; G01N 29/24; G01N 29/36

(52) U.S. Cl. CPC G01B 17/02; G01N 2291/02854; G01N 29/36; G01N 29/24

(57) ABSTRACT

The present invention concerns a system for non-destructive testing of a sample using a combination of intelligent sensors and radio units which allow continuous monitoring, providing data obtained by non-destructive testing. Correspondingly, this invention also provides a method for non-destructive testing of a specimen using a combination of intelligent sensors and radio units that enable continuous monitoring, providing data obtained by non-destructive testing. A special aspect is the self-certifying design of the system or procedure.

### TECHNICAL FIELD

The present invention concerns a system for non-destructive testing of a sample using a combination of sensors and radio units which allow continuous monitoring, providing data obtained by non-destructive testing. Correspondingly, this invention also provides a method for non-destructive testing of a specimen using a combination of sensors and radio units that enable continuous monitoring, providing data obtained by non-destructive testing.

### STATE OF THE ART

Metal hollow bodies such as pipes or reactors are widely used in the chemical industry. Often the materials to be transported or the reactions to be carried out in them are such that continuous structural monitoring is necessary to ensure that, for example, deposits in the interior do not impair functionality, such as the transport of materials or heat conduction. It is also relevant to detect possible reductions in wall thickness in good time, for example in the case of steel pipes used for conveying highly corrosive or abrasive materials. Manual monitoring processes are labour-, time- and cost-intensive, since for a sufficiently precise inspection the systems to be monitored often have to be switched off and partly be emptied or measuring devices have to be installed (complex conventional monitoring methods are for example external visual monitoring, endoscopic camera inspection, monitoring with X-rays). Only then can the test be carried out, which often cannot be carried out non-destructively, as samples may be removed from a system and then analysed for testing purposes. Furthermore, such monitoring and testing processes make it difficult to reliably estimate during operation when a component of a plant needs to be replaced or when, for example, internal deposits need to be removed. This uncertainty leads to high costs, since on the one hand parts are replaced earlier than necessary (to ensure plant safety) and on the other hand manual inspections are carried out at shorter intervals. Another special requirement with regard to possible automatic monitoring is that it may be necessary for the sensors used to have a system of self-certification and fault testing. Such a system would make it possible to check the measurement accuracy and freedom from interference of the sensor even without manual intervention, to ensure the reliability of the measurement results to such an extent that, for example, certification becomes possible despite the no longer required manual inspection. For reasons of occupational safety, it is also important to relieve employees of work/attendance in critical areas as far as possible.

Non-destructive techniques have been developed in the field of structural health monitoring (SHM), for example in aircraft construction. Non-destructive testing makes it possible to detect various types and sizes of defects and to determine the material properties. Traditional techniques for non-destructive testing of specimens, such as fiber-reinforced plastics, include ultrasonic and thermographic testing. In pulse-echo ultrasonic non-destructive testing, for example, a pulse passes through the sample and is reflected from the opposite surface of the sample. Defects within the sample reflect, absorb or disperse the pulse in such a way that a pulse echo from the opposite sample surface is reduced. Problematic with such structures are the damage reaction and the damage monitoring. In this context, SHM methods are known in which measurement signals are acquired with separately used elements. Such signal acquisition takes place both on dormant structures and on structures in use.

GB 2 544 108 A1, DE 196 06 083 A1 and DE 2 035 777 reveal methods for determining wall thickness.

### Task of the Invention

Due to the relevance of such structural monitoring systems, for example for pipes and reactors made of steel or pipes, reactors and other structures made of fibre-reinforced plastics which are widely used in the chemical industry, improved systems for SHM are in demand. Frequently, highly corrosive and/or toxic compositions are transported and converted in such pipes and reactors, so that close monitoring of structural integrity is important to avoid damage. A particular challenge is to be seen in the fact that metallic elements as well as fibre composite materials cannot be optically monitored from the outside.

Therefore it is the task of the present invention to specify a system and procedure for structure monitoring which non-destructively monitors the structural integrity in such plants or on such components and transmits the data obtained to a central data processing unit so that an automatic and continuous acquisition and evaluation is possible.

### Short Description of the Invention

The inventive system for non-destructive condition monitoring therefore comprises the components defined in claim 1. Preferred configurations are indicated in the dependent claims. On the basis of the following description, which contains additional preferred embodiments, the skilled person will understand that the present invention is not limited to the specifically described combinations of features but that further combinations and embodiments result for the skilled person, which are included and protected here.

### DETAILED DESCRIPTION OF THE INVENTION

The system in accordance with the invention comprises at least one structure, such as a hollow body (pipe, conduit, reactor) or similar, made of a metallic material, preferably steel, or a fibre composite material, such as GRP (glass fibre reinforced plastics) or CRP (carbon fibre reinforced plastics). Another possible alternative is that the structure should consist of a hybrid material, such as GRP pipes, which are coated with plastic, such as polypropylene. This is the component to be monitored. This hollow body is also equipped with a sensor which is positively connected to the structure to be monitored.

Examples of structures to be monitored (hollow bodies, reactors, etc.) are plants in the chemical industry, refineries, pipelines, offshore structures, such as (oil platforms, or other platforms, pumping stations, etc.). These can be above ground, underground or even under water. One advantage of this invention is that, for example, buildings buried in the ground can also be monitored without the need for earth works.

This intelligent sensor is referred to in the following as an ultrasonic sensor and comprises in particular a probe and a controller unit. In principle, such sensors are known to experts. This sensor is used to measure the thickness of the hollow body, i.e. the wall thickness. The ultrasonic measurement technique is a transit time measurement on the hollow body (also called sample body). In a familiar way, a thickness/wall thickness can be calculated/determined from the specific transit time of the signal, taking into account the temperature dependence of the measurement (this can be taken into account mathematically by suitable correction procedures). Since the original wall thickness is known for that measuring point (or can be determined before the sensor is attached), a change can be reliably detected by the regular measurements. The inventive system can carry out measurements over a wide temperature range. A preferred temperature range is 20° C. to 150° C., especially 50° C. to 120° C., as from 70° C. to 100° C. According to the invention, an extension of the temperature range up to about 400° C. is also possible, as long as the necessary ultrasonic probes are used.

According to the invention, the time required for the ultrasonic pulse to pass through the specimen is determined. Since both the material composition (e.g. alloy composition and the respective material constants, or in the case of fibre composites the type of matrix material and the type of fibre reinforcement, again with the respective material constants) of the specimen and the condition of the specimen before installation in the building (such as wall thickness, inner diameter and outer diameter) are known, deviations from this condition can be detected by such a transit time measurement. Since the temperature can also be recorded by the sensor system according to the invention, a very exact determination of the wall thickness (or determination of the occurrence of disturbances) is possible. The evaluation unit described here can carry out an exact calculation by taking the material properties and the recorded variables into account, since corrections due to temperature influences in particular can be taken into account precisely. It has been shown that, for example, deposits in the interior which reduce the inner diameter and may lead to flow disturbances (i.e. increase in the wall thickness) can be detected well in this way. It is also possible to detect a reduction in wall thickness due to abrasion or corrosion. Such deviations from the target state can be detected with high accuracy by the inventive system. The advantage is that one-sided accessibility is completely sufficient for structure monitoring.

According to the invention, such sensors are joined to the component to be monitored in a form-fit manner, whereby this can already be done during the design of the component. However, retrofitting of already installed components is also possible. A firm connection, such as by the use of small devices, (metal) tapes or clamps, or even welding, has proved to be suitable. However, it is also possible to bond such sensors to the specimens to be monitored, for example using epoxy materials. At the same time, this also enables condition monitoring during operation, since a detected change in amplitude is a clear indication that the joining with the component is no longer sufficient (i.e. the sensor has at least partially detached itself; this also applies to the particularly preferred design described below).

The probe geometry can be selected depending on the specimens to be monitored. In a version of the present invention, weld seams, both in metallic test pieces and in plastic-based test pieces (i.e. the structures to be monitored), can also be subjected to monitoring in accordance with the principle of the present invention. Here, the wall thickness determination or thickness determination described in the context of disclosure can be understood as monitoring the integrity of the weld seam (i.e. whether the weld seam is intact and without imperfections or faults, i.e. whether the “wall strength/thickness” of the weld seam corresponds to the wall thickness of a pipe, for example, or not). An angle probe is preferably used to avoid coupling problems/joining problems with the possibly uneven weld seam. At the same time, this overcomes the disadvantage that damage perpendicular to the sound path may not be detected with sufficient clarity when using a conventional probe. Nevertheless, this invention can also be used for self-certifying monitoring of welding seams, especially in consideration of the following remarks.

One problem of such monitoring is, however, that if measurement results indicate a deviation of the wall thickness, there is no final certainty that these measurement results are actually correct. It is also often problematic with ultrasonic systems to safely monitor pipes etc. with quite small wall thicknesses, for example of 2 mm or less.

It has been shown that these problems can also be overcome by comparatively simple modification of the sensor. For this purpose, the sensor probe is not applied directly to the structure to be monitored, but a layer of plastic, such as polycarbonate, is provided between the sensor and the structure. The only requirement for this plastic part is that it needs to be stable at the relevant temperature of the structure to which it is attached (i.e. the temperature which occurs during normal operation of the structure). This can be done in such a way that this material is provided in a defined length (suitable lengths are from a few millimetres to about one centimetre, such as from 3 to 10 mm, preferably 5 to 10 mm, in execution forms 5 to less than 10 mm) on the sensor (so that this material is available in use between building and sensor probe). Such a material layer leads to a delay of the signal, since the impulse emitted by the sensor must first pass through this material layer before it passes through the structure to be monitored. At the same time, a thermal separation between the test specimen and the probe is achieved. It has now been shown that, due to the fact that this material layer, preferably a plastic layer, does not in principle change during the use of the sensor, the associated delay (the time the signal needs to pass through this feed path) is a measurand that allows the monitoring of the functionality and freedom from interference of the sensor (since the geometry of the feed path remains constant, so that it can be used as a measuring standard). The delay described here can be determined as a measured variable before the sensor is used (here, for example, certification agencies can determine the measured variable, so that certification of the system as a whole, which is subject to continuous self-certification during operation, becomes possible). This delay can be determined again for each measurement. Only if the value measured in active operation matches the value determined at the input (and certified, if applicable), is it ensured that the sensor operates trouble-free. If this is not the case, the sensor can be suppressed (i.e. elimination of the interference/malfunction) from a remote location, if necessary via software import or other correction mechanisms, in particular via the combination with the radio unit described in more detail below. In any case, this function is associated with the fact that sensors that are no longer working trouble-free can certainly be identified without the need for manual on-site testing. At the same time, it has been shown that this self-check can also be safely monitored for structures with comparatively low wall thicknesses due to the determinable delay. This makes it possible for the bi-directional sensors described below (i.e. sensors that can both send data and receive data) that third parties such as certification bodies (TUV etc.) can also check the functionality and freedom from interference of sensors. To do this, a specific measurement protocol must be transmitted to the sensor, which determines the delay described above, caused by the passage through the lead section (and transmits the measurement result). If the measured value corresponds to the value determined in advance for the respective sensor, the certification body can confirm the trouble-free operation of the sensor from a distance (without on-site personnel). This is then, for example, recorded by the certification body and/or documented by the respective operator before each measurement is recorded. Such a system is ultimately a self-certifying system. Despite the seemingly relatively simple modification with the plastic element serving as a measuring standard between the specimen and the probe, this results in unexpectedly large advantages, since such a self-certifying system has extraordinary advantages.

By using suitable ultrasonic impulses, the sensor can therefore acquire data that allow conclusions to be drawn about the condition of the specimen. It is possible to use ultrasonic pulses over the entire ultrasonic frequency window. The range from 4 to 8 MHz is preferred, for example 5, 6 or 7 MHz. By matching it with the exact specifications of the specimen (material composition, wall thicknesses, etc.), optimum measuring ranges can be easily adjusted to the specific individual case. Scanning with the waves thus permits continuous condition monitoring and, if necessary, the characterization of local defects. The method is suitable for non-destructively tracking the effect of these defects on fatigue mechanisms during cyclic loading during operation. This can be used to generate data that can be used to evaluate the specimen or its suitability for maintaining the desired functionality, static load and dynamic load (in forms of execution, this evaluation can be performed quasi in real time).

The data evaluation then takes place, for example, on the basis of procedures known from ultrasonic material testing. An essential advantage of the inventive system is to be seen in the direct recording of damaging events.

At the same time, this sensor is connected to a controller or radio unit also provided on the structure to be monitored. These components are used for data transfer to a central data acquisition and evaluation system. The unit consisting of sensor and radio unit is preferably designed in such a way that long-term use is possible. This unit can also be equipped with a battery for a sufficiently long power supply. In this way, multi-year operating periods can be secured.

The central data acquisition system can be a cloud based system or an application server, so that a strong spatial separation is possible and for example optimal computer capacities can be used. If necessary, so-called gate devices can be interconnected in order to completely transmit the data of a large number of sensors to the data acquisition and evaluation unit. The inventive system can, of course, include a large number of such sensors, making it possible to monitor a larger installation. In the case of large (extensive) systems to be monitored, where it may not be possible to ensure that the data from the individual sensors can be securely transmitted to a central unit (since the distance is too long for secure wireless transmission), individual areas of the system can be equipped with individual receivers (gateway installations) so that even extensive systems can be safely monitored. This results in contiguous or overlapping areas in which the individual sensors can communicate with the respective gateway installations, so that all data obtained can be transmitted securely. Such systems are called LORAWAN systems according to the invention, i.e. “long range wide area network” systems.

Such monitoring systems therefore comprise a large number of sensors, each equipped with a radio unit for wireless data transmission and positively connected to the structures/hollow bodies to be monitored. Depending on the size of the system, such a system also includes at least one gateway installation to receive the data (and forward it to a central data acquisition and processing unit). The data of the several sensor units can thus be processed centrally. Since the sensors continuously collect the data and transmit it in an appropriate manner, the central data acquisition and processing unit can continuously process the received data in order to filter out the information necessary for structure monitoring from the raw data. The data processing programs to be used in this context are familiar to the expert.

Such radio units can preferably be designed in such a way that data can be both transmitted and received. Bidirectional sensors of this type can be supplied with software updates, fault checking programs and fault rectification programs etc. by external (remote) access, which simplifies maintenance work etc. on the sensor system, since maintenance personnel need not be on site for every check or fault rectification.

The advantage of the method according to the invention and thus of the system according to the invention compared to classical methods is that in principle they can provide clues about the operability of a component at any time and/or continuously track the emergence of problems in real time, so that an alarm function can be ensured by a suitable control of the evaluation. Depending on the method of data evaluation, the stress state can also be continuously described (in the following also CMS, “condition monitoring system”). Due to the continuous structure monitoring, such a system can point out weak points in the running operation of a plant in time, so that maintenance work and repairs can be carried out more specifically. Since the monitoring takes place continuously during operation, undesired downtimes can be avoided. This system can also be designed in such a way that, for example, warnings are automatically transmitted to the personnel responsible for a specific part of the plant when weak or problematic points are identified, so that the necessary further steps can then be taken without delay. The system can also automatically suggest the steps to be taken in the configuration and, for example, place material orders etc.

Furthermore, the collected data can be used for acute control/monitoring as well as for prediction (prediction) of changes in the condition of the monitored building using suitable statistical methods (e.g. running on the application server or in the cloud based system). By using suitable algorithms, statistically sound calculations can be performed for the “residual material life” (how long is the monitored structure to be regarded as stable within the specified values). This means that a warning can be generated by the system even before a (malfunction) event occurs, so that maintenance and/or replacement work can be planned again with a very good lead time. The data history obtained can also be combined with other data, for example from other types of material tests, the respective plant control system or other data from the operation of the monitored plant, in order to enable further more complex data evaluations or to generate more detailed data for a monitored plant (which again may enable better and more precise data analysis or provide data for events/situations that have not yet been evaluated).

In this way, continuous monitoring can take place without switching off the plant to be monitored, without the need for personnel, as the sensors and radio units generate, transmit and record the data independently. In accordance with application-specific presets, the system can then continuously transmit status reports based on the received data so that necessary maintenance/repair work can be scheduled in a timely manner and performed in accordance, for example, with normal shutdowns (for cleaning operations or when switching to other reactions/materials). This also reduces the time required for such maintenance and repairs, as these can be better planned. The continuous monitoring of the system also means that the maintenance-relevant structural data is continuously recorded and evaluated, so that it is often possible to predict well in advance when maintenance and repair work will have to be carried out at the latest. This also simplifies the workflow in such systems.

By using the inventive system, which includes contactless data transmission, it is also possible to avoid costly cabling, which is both labour-intensive and costly. Through the use of known sensor technologies, even extensive systems can be continuously monitored, since the radio modules used enable secure data transmission even over radio distances of several kilometres.

It has been shown that a system described above can be used to safely monitor components and entire systems made of the materials and materials described here, such as metallic materials, in particular steel. Buildings/hollow bodies with different wall thicknesses and diameters can be easily monitored, for example pipes with wall thicknesses of one millimetre or more, for example a few millimetres or centimetres and diameters of a few inches.

The inventive system is suitable for monitoring critical points in a plant or component, but a complete plant can also be monitored. The only requirement is that a sufficient number of sensors be installed on the system. With ultrasonic sensors, it is sufficient to distribute the sensors in a system in such a way that the distance between the individual sensors is in the range of 1 to 5 meters, preferably 1 to 3 meters. This ensures complete continuous structure monitoring (SHM and CMS).

With regard to sensor adjustment, it has been shown that the best results are obtained when calibration is performed after installation. This calibration aims to find the measurement frequency at which the received signal is strongest. This allows sufficiently strong and easily interpretable signals to be obtained so that the structure monitoring can be operated with excellent reliability.

As mentioned above, the data evaluation is performed on the basis of the transmitted raw data in a central data processing unit using analytical software for data processing. Due to the continuous and automatic data acquisition and data evaluation, the system can be designed in such a way that the determined status information is automatically transmitted to the intended recipients (maintenance personnel, but also data storage), for example by wireless transmission to end user devices (smartphone/tablet/laptop etc.). Ultimately, this provides a system for condition monitoring which generates condition data continuously, non-destructively and over a long period of time, automatically and wirelessly, and transmits a data acquisition and evaluation unit, and then transmits the condition information and, if necessary, proposals for action (maintenance intervals, specific maintenance or repair work). This creates a communicating system in which a component to be monitored independently and continuously transmits status data through the sensor and radio unit.

The above statements, which are based on the design of the system in accordance with the invention, are easily transferable by the skilled person to the procedure in accordance with the invention. This includes in particular the attachment of the sensor or radio unit described above. The transmission of signals from the sensor and also the transmission to mobile devices, for example, are ensured by protocols that are known in principle. Here, depending on the application, the system and the procedure can be easily adapted to the specific circumstances. This is a further advantage of this invention, as in principle a modular system is provided which is easy to adapt, but at the same time enables simple and reliable condition monitoring.

1. A system for non-destructive structure monitoring of a structure and/or hollow body made of a metallic material, a fibre-reinforced plastic or hybrid materials, comprising:
at least one combination of an intelligent sensor which is positively connected to the structure and/or hollow body to be monitored, and
a radio unit connected to the sensor for transmitting the data obtained by the sensor,
wherein the intelligent sensor is an ultrasonic transit time measurement sensor.

2. Method A method for non-destructive structure monitoring of a structure and/or hollow body made of a metallic material, a fibre-reinforced plastic or hybrid materials, comprising:
obtaining a transmission of data by an intelligent sensor, which is positively connected to the structure and/or hollow body to be monitored, by a radio unit connected to the sensor,
wherein the intelligent sensor is an ultrasonic transit time measurement sensor.

3. The system according to claim 1, with the sensor probe operating in the frequency range from 4 to 8 MHz.

4. The system according to claim 1, wherein the radio unit operates in the frequency range from 850 to 950 MHz, in particular 864 MHz or 915 MHz, wherein the radio unit is preferably a short-range radio unit according to ETSI EN 300 328 V1.7.1.

5. The system according to claim 1, wherein the hollow body is one of a reactor or tube of steel, fiber composites or a hybrid material thereof.

6. The system according to claim 1, wherein the temperature of the structure/hollow body to be monitored is in a temperature range from −20 to 400° C.

7. The system according to claim 1, wherein a plastic layer of defined thickness is provided between the probe of the sensor and the structure and/or hollow body to be monitored.

8. The system according to claim 1, in which several structures and/or hollow bodies are monitored simultaneously and autonomously.

9. The system according to claim 8, where the multiple structures and/or hollow bodies are part of a plant, for example in the chemical industry, refineries, pipelines or offshore structures.

10. The system according to claim 1 further comprising at least one gateway installation to which the data of a defined group are first transmitted to sensors.

11. The system or method according to claim 1, further comprising a data acquisition unit capable of receiving and processing data generated by the at least one sensor (with or without interposition of a gateway installation).

12. The system according to claim 11, wherein the data acquisition unit is designed in such a way that the structural information derived from the data processing is automatically transmitted to mobile terminal devices

13. The system according to claim 10, wherein a plurality of gateway installations are provided so as to result in contiguous or overlapping monitoring areas.

14. The system according to claim 1, wherein the combination of sensor and radio unit is designed to be active for a period of at least 96 months without external energy supply.

15. The system according to claim 1, wherein the sensor is positively connected to the hollow body by bonding or lamination.

16. The system according to claim 1, whereby the data evaluation is suitable for SHM and/or CMS.

17. The system according to claim 1, further comprising facilities for web-based, location-independent visualization of data evaluation.

18. The system according to claim 1, for use wherein the system is used in connection with an online prediction of maintenance.

19. The system according to claim 1, wherein the temperature of the structure/hollow body to be monitored is in a temperature range from 80 to 120° C.

20. The system according to claim 1, wherein the temperature of the structure/hollow body to be monitored is in a temperature range from 200 to 400° C.
